(19) United States
(12) Patent Application Publication
(10) Pub. No.: US 2020/0394857 A1
(43) Pub. Date: Dec. 17, 2020

(54) Unlock Method for an Electronic Locker with Digital Key Transmission

(71) Applicant: Jao Ching Lin, Taipei City (TW)

(72) Inventor: Jao Ching Lin, Taipei City (TW)

(21) Appl. No.: 16/902,355

(22) Filed: Jun. 16, 2020

(30) Foreign Application Priority Data
Jun. 17, 2019 (TW) 108120857

(51) Int. Cl. G07C 9/00

(52) U.S. Cl. CPC G07C 9/00182; G07C 2009/0023; G07C 9/00912

(57) ABSTRACT

The present invention is provided to enhance security and convenience of retrieving storage items from the locker. This can be fulfilled by providing a method where a digital access can be transmitted between different users who have installed certain registerable application software in their electronic device, like mobile phone, tablet computer or PC (personal computer) for unlocking the locker. By receiving and comparing the digital access on the user's electronic device, the locker will be unlocked for items retrieval.

### FIELD OF INVENTION

Present invention is related to an unlock method for an electronic locker; especially to a method for securely unlock an electronic locker with digital key transmission.

### BACKGROUND OF THE INVENTION

Electronic lockers or mechanical lockers are commonly seen at every train station or MRT station for passengers to temporarily store their luggage or personal belongings. When putting their belongings into the locker, each passenger can set up a password or obtain a physical or electronic key for future unlocking and retrieving their storage belongings.

Besides retrieving the belongings by the passengers themselves, some locker users may give the password, physical or electronic key to other people for obtaining the storage items inside. Since the locker will only recognize the password, physical or electronic key instead of the original owner of the storage items, people who have the right password, physical or electronic key can easily have the locker unlocked and reached the storage items inside. This kind of system is considered quite dangerous and left the storage items unprotective if the password, physical or electronic key has been forgotten or stolen. The physical key also brings a lot of troublesome and inconvenience to the users for carrying it around. Hence, it is eager to have a method for securely unlock an electronic locker with digital key transmission that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve the shortcoming of the conventional electronic lockers or mechanical lockers can be simply unlocked by anyone who has the right password or key without authoring by the original owner and to solve the troublesome and inconvenience that the physical key might bring, the present invention is provided to enhance security and convenience of retrieving storage items from the locker. This can be fulfilled by providing a method where a digital key can be transmitted between different users who have installed a certain registerable application software in their electronic device, like mobile phone, tablet computer or PC (personal computer) for unlocking the locker.

In accordance to a first aspect of the present invention, the unlock method for an electronic locker with digital key transmission of the present invention mainly comprises steps of: defining a user's electronic device and a retriever's electronic device on a network, wherein the electronic devices have application software therein respectively, the user's electronic device has an user's identification and the retriever's electronic device has a retriever's identification; reading a locker information, wherein the user's electronic device reads a locker information from an electronic locker and set up a connection therebetween; obtaining a key, wherein the electronic locker locked after the application software of the user's electronic device receives a digital key from the electronic locker, the application software of the user's electronic device generates a digital key file with combining the user's identification, the retriever's identification and the key into a digital key file; and transmitting the digital key file for unlocking the electronic locker, wherein: the retriever's electronic device receives the digital key file from the user's electronic device, the application software of the retriever's electronic device compares the retriever's identification in the received digital key file, the electronic locker is unlocked while the retriever's electronic device is connected to the electronic locker with the matched retriever's identification.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying Figures.

FIG. 1 is flow chart of a preferred embodiment in accordance with the present invention;

FIG. 2 is schematic diagram of a preferred embodiment for putting item inside the locker in accordance with the present invention; and

FIG. 3 is schematic diagram of a preferred embodiment for retrieving storage item from the locker in accordance with the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

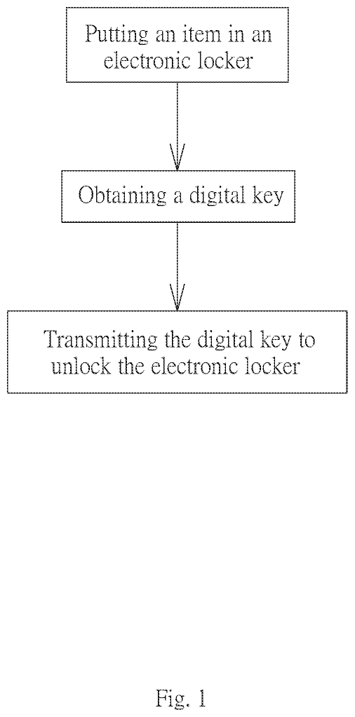

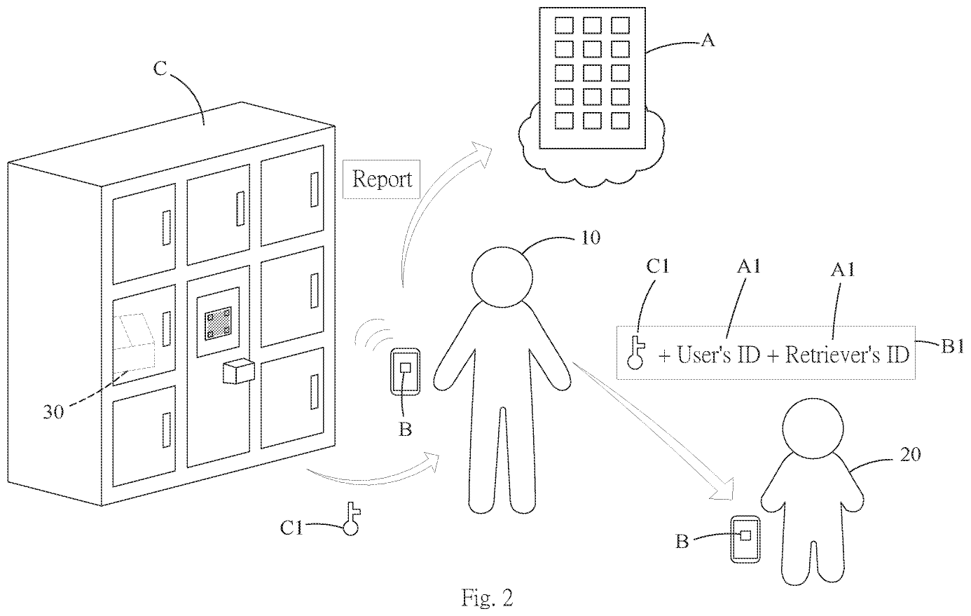

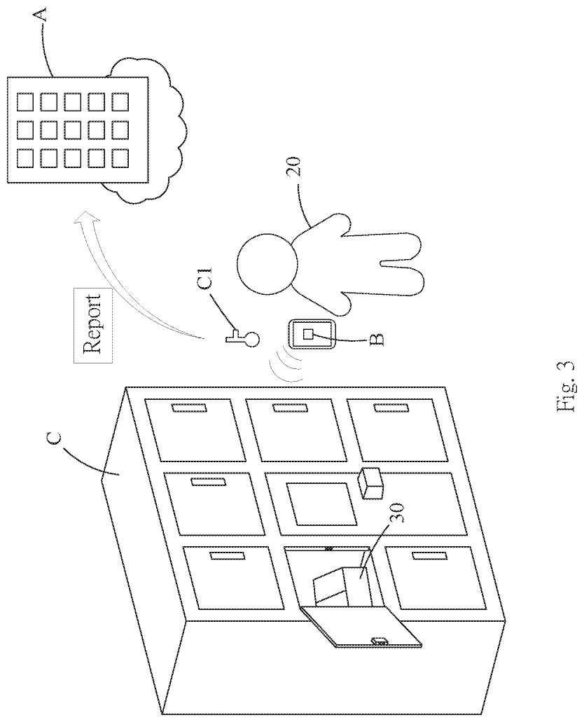

With reference to FIGS. 1 to 3, a preferred embodiment of the present invention comprises steps as followings.

Firstly, an item is put inside an electronic locker by a user 10. A network A (or a web server) provides an application software B that can be downloaded and installed in the user's electronic device. An electronic locker C is set up at certain area, like convince store, train station or MRT station. The electronic locker can be connected and activated by the user's electronic device with the application software B via the conventional wireless connection means, like WI-FI, near field communication or Bluetooth. In this embodiment of the present invention, a locker information like a QR code is appeared on the electronic locker for reading or scanning by the user's electronic device to build the connection therebetween. From now on, the user's electronic device will be taken by an example of mobile phone for clearly description. This has no any intention to limit the scope of the present invention. Electronic devices with internet surfing and wireless connection function are all applicable to the present invention.

The network comprises multiple registered users who has downloaded or installed the application software B. The network can have hundreds of thousands or even tens of millions of registered users. The present invention can be activated by simply one user 10 and one retriever 20 from the registered users. Each registered user has an identification code A1 where the identification codes held by the user 10 and the retriever 20 will be referred as “user's identification” and “retriever's identification” in the following description, respectively. The identification code A1 can be some random numbers that the network Assigned to the registered users or also can be the user's mobile phone number, MAC address, serial number or recognizable pattern. When the user 10 seeks a place to temporarily store his belongings, the user 10 can put his item 30 into the electronic locker C.

Secondly, an access C1, such as a digital key will be obtained by the user 10. After the user 10 put the item 30 into the electronic locker C, he can connect his mobile phone with the electronic locker C by activating the application software B. The user 10 then can select the desired retriever 20 to retrieve the item 30 inside the electronic locker C. The electronic locker C will transmit the access C1 to the application software B installed in the user's mobile phone. A function of the access C1 is to unlock the electronic locker C. After obtaining the access C1, the electronic locker C is securely locked. When the user 10 obtain the access C1 by the application software B, the application software B will report this operation back to the network A and start counting time. The application software B will compile an access file B1 by using the access C1, the user's identification A1 and the selected retriever's identification A1. The retriever's identification A1 in this embodiment is the retriever 20's mobile phone number.

Thirdly, the access file B1 is transmitted to the retriever 20 to unlock the electronic locker C. The application software B in the user's mobile phone can transmit the access file B1 to the mobile phone of the retriever 20 by suitable wireless transmission technique, like WI-FI, near field communication, or Bluetooth. The application software B installed in retriever 20's mobile phone will decrypt the access file B1 to obtain the access C1, the user's identification A1 and the retriever's identification A1. The retriever's identification A1 obtained from the decrypted access file B1 will then be compared with the retriever's identification A1 to see if these two identifications are identical (in this case, the retriever 20's mobile phone number). If the decrypted retriever's identification A1 matches with the original retriever's identification A1, the electronic locker C can be unlocked by the retriever 20's mobile phone.

Finally, after the application software B installed on the retriever 20's mobile phone connected with the electronic locker C, the access C1 will unlock the electronic locker C for the retriever 20 to obtain the storage item 30. The application software B installed on the retriever 20's mobile phone will also report this operation back to the network A again to stop the time counting. The time lapse from the first reported operation (putting item 30 into the locker C) to this final reported operation (retrieving the item 30 from the locker C) will charge the user 10 or the retriever 20 for money, whoever is assigned to pay. The payment methods include but not limit to credit card deposit or the user's value stored in the network A.

Another embodiment of transmitting the access C1 from the user 10 to the retriever 20 can be achieved by email or texting via Internet or Bluetooth. The access C1 can also be transmitted by portable USB or hard disk. Another embodiment of the present invention, the mobile phone can be a tablet computer or a smart watch. The user 10 may also be the same person as the retriever 20.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. An unlock method for an electronic locker with digital key transmission comprising steps of:
defining a user's electronic device and a retriever's electronic device on a network, wherein the user's electronic device and the retriever's electronic devices have a application software therein respectively, the user's electronic device has an user's identification and the retriever's electronic device has a retriever's identification;
reading a locker information by the user's electronic device from an electronic locker and setting up a connection therebetween;
obtaining a access, wherein the electronic locker locked after the application software of the user's electronic device receives the access from the electronic locker, the application software of the user's electronic device generates a digital access file with combining the user's identification, the retriever's identification and the key into a digital access file; and
transmitting the digital access file for unlocking the electronic locker, wherein: the retriever's electronic device receives the digital access file from the user's electronic device, the application software of the retriever's electronic device compares the retriever's identification in the received digital access file, the electronic locker is unlocked while the retriever's electronic device is connected to the electronic locker with the matched retriever's identification.

2. The method as claimed in claim 1, wherein the retriever's identification is a mobile phone number, a MAC address, a serial number or a recognizable pattern.

3. The method as claimed in claim 2, wherein the electronic locker is connected with the electronic device by near field communication, Bluetooth, wireless communication or scanning a pattern on electronic locker.

4. The method as claimed in claim 1, wherein the user and the retriever is a same person.

5. The method as claimed in claim 3, wherein the access is transmitted by the application software via Internet, email, universal serial bus, electronic message or portable disk.

6. The method as claimed in claim 1, wherein:
the user and the retriever are defined in a web server and the web server provides the application software;
when the access is obtained by the user's electronic device, the application software reports this operation back to the network and start time counting;
the application software of retriever's electronic device connects to and opens the electronic locker and the retriever's electronic device reports the network to stop time counting; and
the network charges the user or the retriever for time lapse from the first reported operation to the final reported operation.

7. The method as claimed in claim 2, wherein:
the user and the retriever are defined in a network and the network provides the application software;
when the access is obtained by the user's electronic device, the application software reports this operation back to the network and start time counting;
the application software of retriever's electronic device connects to and opens the electronic locker and the retriever's electronic device reports the network to stop time counting; and
the network charges the user or the retriever for time lapse from the first reported operation to the final reported operation.

8. The method as claimed in claim 3, wherein:
the user and the retriever are defined in a network and the network provides the application software;
when the access is obtained by the user's electronic device, the application software reports this operation back to the network and start time counting;
the application software of retriever's electronic device connects to and opens the electronic locker and the retriever's electronic device reports the network to stop time counting; and
the network charges the user or the retriever for time lapse from the first reported operation to the final reported operation.

9. The method as claimed in claim 4, wherein:
the user and the retriever are defined in a network and the network provides the application software;
when the access is obtained by the user's electronic device, the application software reports this operation back to the network and start time counting;
the application software of retriever's electronic device connects to and opens the electronic locker and the retriever's electronic device reports the network to stop time counting; and
the network charges the user or the retriever for time lapse from the first reported operation to the final reported operation.
